(19) United States
(12) Patent Application Publication
(10) Pub. No.: US 2025/0290547 A1
(43) Pub. Date: Sep. 18, 2025

(54) ROLLING BEARING WITH AXIAL STOPS, IN PARTICULAR FOR A STEERING COLUMN

(71) Applicant: AKTIEBOLAGET SKF, GOTEBORG (SE)

(72) Inventors: Thomas LEPINE, Tours (FR); Baptiste VIDIL, Levallois-Perret (FR); Bruno MONTBOEUF, Saint-Cyr-Sur-Loire (FR); Lucia KNOBLAUCH, Buchheim (DE)

(21) Appl. No.: 19/070,815

(22) Filed: Mar. 5, 2025

(30) Foreign Application Priority Data
Mar. 13, 2024 (FR) 2402493

(51) Int. Cl. F16C 33/58; F16C 19/06

(52) U.S. Cl. CPC F16C 33/583; F16C 19/06; F16C 2326/01

(57) ABSTRACT

A rolling bearing for a steering column including a first ring, a second ring, and at least one row of balls arranged between the rings. The second ring includes a casing and at least one insert element arranged in the casing and forming a bearing race of the second ring, and at least one prestress element mounted in the casing and exerting an axial force on the insert element. The first ring has a bearing race having, in cross section, a concave inner profile, and at least one first thrust surface extending from a first axial end of the bearing race obliquely toward the outside in the direction of the second ring.

### CROSS-REFERENCE

This application claims priority to French patent application no. 2402493 filed on Mar. 13, 2024, the contents of which are fully incorporated herein by reference.

### BACKGROUND OF THE INVENTION

The present invention relates to rolling bearings, and more particularly to rolling bearings used in the steering columns of motor vehicles.

Steering columns generally comprise a shaft, one end of which is fixedly attached to a drive steering wheel actuated by the driver of the vehicle, and the other end of which is fixedly attached to mechanical members intended to ensure the angular positioning of the wheels of the vehicle. The shaft of the steering column is rotatably mounted in a tubular housing via two rolling bearings.

A type of rolling bearing for a steering column includes an inner ring, an outer ring and a row of balls arranged between bearing races of the rings, at least one of the rings comprising a casing and insert elements arranged in the casing for forming bearing races of the ring. This produces a rolling bearing with three or four contact points, capable of functioning under axial and/or radial loads. Generally, such a bearing also comprises an elastic prestress element which is mounted inside the casing and bearing axially against one of the insert elements so as to obtain a function with limited movements.

The architecture of such a rolling bearing allows avoidance of the presence of free play in the bearing, but does not totally limit the axial and radial movements between the rings, even when the bearing preload is adjusted after installation.

### SUMMARY OF THE INVENTION

The object of the present invention is to rectify the drawbacks described above.

More specifically, the present invention is a rolling bearing, in particular for a steering column, comprising a first ring, a second ring and at least one row of balls arranged between the rings, the second ring comprising a casing, at least one insert element arranged in the casing for forming a bearing race of the second ring, and at least one prestress element mounted in the casing and exerting an axial force on the insert element.

As used herein, an “insert element” is an element which is separate from the casing.

According to a general characteristic, the first ring is provided with a bearing race having, in cross section, a concave inner profile, and at least one first thrust surface extending, from a first axial end of the bearing race, obliquely towards the outside in the direction of the second ring.

The thrust surface forms a change of slope relative to the bearing race in its region of connection to the race.

The thrust surface forms an axial stop allowing blocking of the axial movement of the row of balls. Thus, the relative axial and radial movements between the first and second rings are limited. This also allows an increase in the axial stiffness of the bearing.

Preferably, the thrust surface of the first ring is frustoconical in form.

In cross section, the thrust surface of the first ring extends preferably perpendicularly to an oblique straight line joining the first axial end of the bearing race and the contact point between the ball and the insert element of the second ring, which is axially on the side opposite the thrust surface relative to the ball.

Advantageously, the first ring includes an annular surface from which the bearing race is formed, the thrust surface being connected to the annular surface.

In an embodiment, the thrust surface is connected to the annular surface via a chamfer.

Advantageously, in cross section, the thrust surface extends obliquely, from the first axial end, from the side of the concave inner profile of the bearing race.

In an embodiment, the first ring includes a second thrust surface extending, from a second axial end of the bearing race opposite the first axial end, obliquely towards the outside in the direction of the second ring.

The second thrust surface of the first ring is preferably symmetrical to the first thrust surface relative to a radial plane passing through the center of the balls.

In an embodiment, the second ring comprises two insert elements which are arranged in the casing on either side of a radial plane passing through the center of the balls.

Preferably, the two insert elements of the second ring are identical or identically formed.

In an embodiment, the first ring is the inner ring of the rolling bearing and the second ring is the outer ring of the rolling bearing.

The invention also concerns a steering column comprising a housing, a shaft coaxial to the housing, and at least one rolling bearing as defined above, mounted radially between the housing and the shaft.

### BRIEF DESCRIPTION OF THE SEVERAL VIEWS OF THE DRAWINGS

Further aims, characteristics and advantages of the invention will appear from reading the following description, given solely as a non-limiting example and with reference to the appended drawings on which:

FIG. 1 is an axial cross-sectional view of a rolling bearing according to an exemplary embodiment;

FIG. 2 is a detail view from FIG. 1;

FIG. 3 is a detail cross-sectional view of a rolling bearing according to another exemplary embodiment; and

FIG. 4 is a detail cross-sectional view of a rolling bearing according to yet another exemplary embodiment.

### DETAILED DESCRIPTION OF THE INVENTION

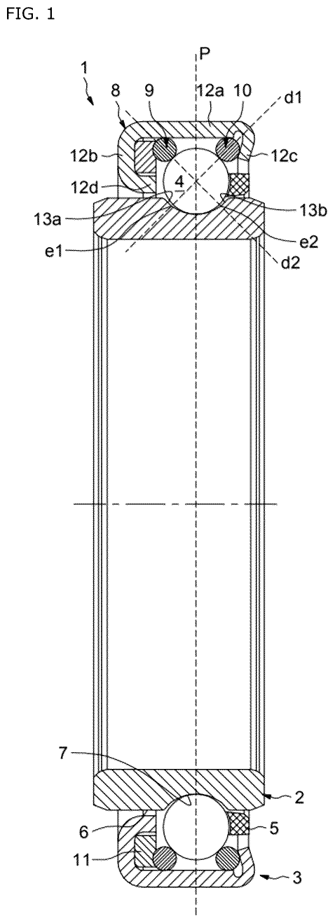

FIG. 1 illustrates a rolling bearing, designated by the numerical reference 1, comprising a first ring 2, a second ring 3 and a row of balls 4 arranged between the two rings 2, 3. In this embodiment, the rolling bearing 1 further comprises a cage 5 arranged radially between the rings 2, 3 so as to maintain a regular circumferential spacing between the balls 4. Alternatively, the rolling bearing 1 may be provided without any cage.

In this embodiment, the first ring 2 is the inner ring of the rolling bearing 1, and the second ring 3 is the outer ring of the rolling bearing 1.

The inner ring 2 has an inner cylindrical bore axially delimited by opposing radial front faces and an outer axial annular surface 6, from which a toroidal circular groove is formed having, in cross section, a concave inner profile suitable for forming a bearing race 7 for the balls 4, the groove being oriented or facing radially toward the outside.

As will be described in more detail below, the inner ring 2 comprises thrust surfaces 13a, 13b for limiting the movement of the balls 4 axially along it.

The inner ring 2 is solid. As used herein, a “solid ring” means a ring formed by machining with removal of material chips (turning, grinding, etc.) from tubes, bars, forged and/or rolled blanks.

The outer ring 3 comprises an outer casing 8 and two separate insert elements 9, 10 forming bearing races of the ring 3 for the balls 4. Preferably, the insert elements 9, 10 take the form of two separate annular beads or rings. The outer ring 3 also includes a prestress element 11 exerting an axial force on one of the insert elements 9, 10. The insert elements 9, 10 and the prestress element 11 are mounted inside the casing 8.

The casing 8 is preferably manufactured by cutting and deep-drawing or bending a plate of sheet metal. The casing 8 is annular in form and includes an outer axial portion 12a and two radial portions 12b, 12c each extending radially inwardly from a separate axial end of the axial portion 12a. The insert elements 9, 10 are arranged in radial contact with the bore of the axial portion 12a and are arranged in the casing 8 on either side of a radial plane P passing through the center of the balls 4. The radial portion 12c has a radial dimension or length less than a radial dimension/length of the radial portion 12b, and also has a reduced thickness so as to have a slight inward curve in the direction of the balls 4 such that the radial portion 12c rests against the insert element 10 and axially prestresses the bearing 1. The cage 5 is disposed radially between the free, inner edge of the radial portion 12c of the casing 8 and the outer surface of the inner ring 2.

The casing 8 also includes an inner axial portion 12d which extends axially from a small-diameter edge of the radial portion 12b and toward the inside of the casing 8. The axial portion 12d is provided for centering the prestress element 11 inside the casing 8.

The prestress element 11 is annular in form and is mounted axially in contact against both the radial portion 12b of the casing 8 and the insert element 9, and is located radially between and spaced apart from the outer axial portion 12a and the inner axial portion 12d. More specifically, a radial surface of the prestress element 11 is in axial contact with the inner face of the radial portion 12b and an opposite radial surface is in axial contact with the insert element 9. The prestress element 11 remains at a distance from, i.e., spaced apart from, the balls 4. The prestress element 11 exerts a permanent axial force on the insert element 9, which tends to prestress the balls 4 against the other insert element 10 and against the groove or race 7 of the inner ring 2.

The prestress element 11 is advantageously formed from an elastic material, for example an elastomer such as nitrile rubber or polyurethane. In the illustrated embodiment, the prestress element 11 has the form of a torus with square cross sections. Alternatively, the prestress element 11 may have cross sections with another profile, for example circular.

The insert elements 9, 10 each take the form of an open torus and are mounted inside the casing 8, in direct contact therewith. The balls 4 are arranged between the insert elements 9, 10 of the outer ring 3, which form or provide the bearing races, and the bearing race 7 of the inner ring 2. This produces a rolling bearing 1 with three contact points. In the illustrated exemplary embodiment, the insert elements 9, 10 are preferably formed identical to each other so as to reduce manufacturing costs.

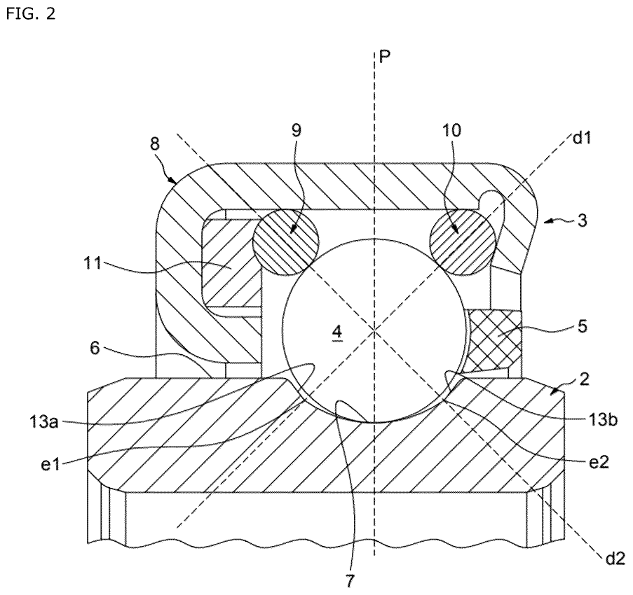

As illustrated more clearly in FIG. 2, the bearing race 7 of the inner ring 2 has a first axial end e1 and a second axial end e2, which define the axial length of the bearing race 7. The first and second axial ends e1, e2 are radially offset on the side opposite the outer ring 3, i.e. towards the inside, relative to the outer axial annular surface 6. The first and second axial ends e1, e2 are aligned with respect to the axial direction.

The first axial end e1 is axially located on the same side as the prestress element 11 relative to the radial plane P passing through the center of the balls 4 and the second axial end e2 is axially located on the opposite side.

The inner ring 2 includes a first annular thrust surface 13a which is frustoconical in form or shape and extends from the first axial end e1 of the bearing race 7 obliquely toward the outside in the direction of the outer ring 3 as far as the outer axial annular surface 6. The thrust surface 13a is connected on one side to the outer axial annular surface 6 of the inner ring 2 and on the other side to the bearing race 7. The thrust surface 13a thus extends between the first axial end e1 of the bearing race 7 and the annular surface 6 of the inner ring 2. The thrust surface 13a may be connected to the annular surface 6 via a chamfer.

In cross section, the thrust surface 13a extends obliquely from the first axial end e1 on the inner side of the concave inner profile of the bearing race 7. In other words, the thrust surface 13a is closed towards the inside of the arc of the bearing race 7.

In cross section, the thrust surface 13a intersects an oblique straight line d1 which joins the first axial end e1 of the bearing race 7 of the inner ring 2 and the contact point between the ball 4 and the axially opposite insert element 10. The angle (not indicated) formed between the thrust surface 13a and this oblique straight line d1 may, for example, have a value between about twenty-five degrees (25°) and about eighty-five degrees (85°). The inner ring 2 also includes a second thrust surface 13b which extends, from the second axial end e2 of the bearing race 7, obliquely in the direction of the outer ring 3 as far as the outer axial annular surface 6. The thrust surface 13b is connected on one side to the outer axial annular surface 6 of the inner ring 2 and on the other side to the bearing race 7. The second thrust surface 13b thus extends between the second axial end e2 of the bearing race 7 and the annular surface 6 of the first inner ring 2. The thrust surface 13b may be connected to the annular surface 6 via a chamfer.

In cross section, the thrust surface 13b extends obliquely, from the second axial end e2, on the inner side of the concave inner profile of the bearing race 7. In other words, the thrust surface 13b is closed towards the inside of the arc of the bearing race 7.

In cross section, the thrust surface 13b intersects an oblique straight line d2 which joins the second axial end e2 of the bearing race 7 of the inner ring 2 and the contact point between the ball 4 and the axially opposite insert element 9. The angle (not indicated) formed between the thrust surface 13b and this oblique straight line d2 may, for example, have a value of between about twenty-five degrees (25°) and about eighty-five degrees (85°).

The thrust surfaces 13a, 13b may be symmetrical relative to the radial plane P passing through the center of the balls 4.

The thrust surfaces 13a, 13b of the inner ring 2 form axial stops allowing blocking of, i.e., preventing, any axial movement of the row of balls 4.

In this exemplary embodiment, the outer ring 3 includes two insert elements 9, 10 in the casing 8, taking the form of beads or rings for forming or providing the bearing races of the outer ring 3.

Alternatively, it is possible to provide other designs of the outer ring 3.

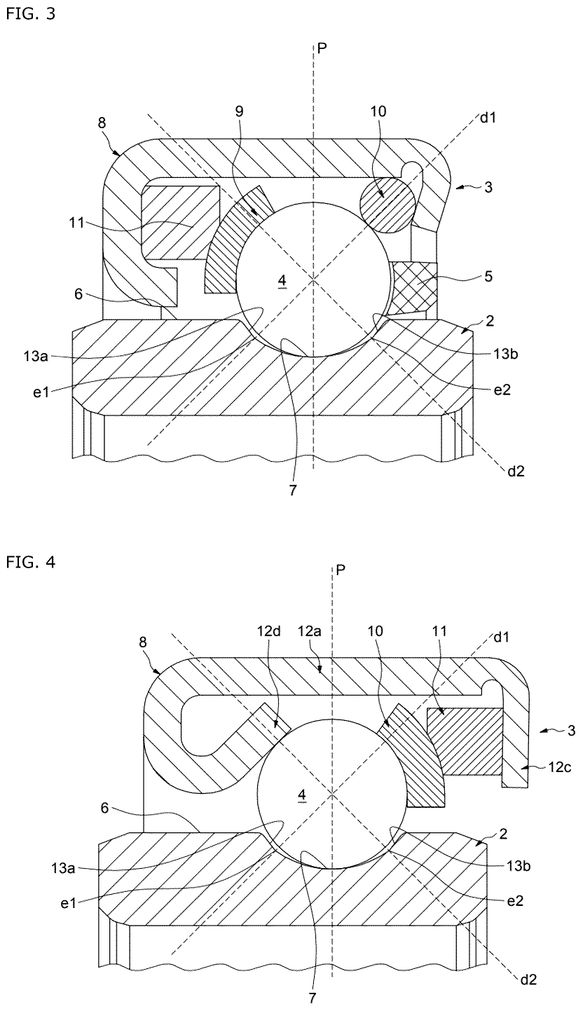

For example, as illustrated in FIG. 3 in which the identical elements carry the same references, the outer ring 3 includes an insert element 9 having the form of a cup which defines a bearing race for the balls 4.

In the exemplary embodiment illustrated in FIG. 4, in which the identical elements carry the same references, the outer ring 3 comprises a single insert element 10 in the form of a cup which defines a bearing race for the balls 4 and the inner axial portion 12d of the casing 8 extends obliquely (and radially outwardly) from the inner edge of the radial portion 12b and defines or provides a bearing race for the balls 4. In this example, the prestress element 11 is axially arranged between the radial portion 12c of the casing and the insert element 10.

As indicated above, in the illustrated exemplary embodiments, the first ring 2 of the bearing is the inner ring and the second ring 3 is the outer ring. Alternatively, it is possible to provide an inverse arrangement in which the first ring 2 is the outer ring and the second ring 3 is the inner ring. In this case, the bearing race 7 and the thrust surface or surfaces 13a, 13b are formed on the bore of the outer ring 2 which forms an inner surface of the ring 2.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A rolling bearing for a steering column, the rolling bearing comprising:
a first ring with a bearing race;
a second ring including a casing, at least one insert element arranged in the casing and forming a bearing race of the second ring, and at least one prestress element mounted in the casing and exerting an axial force on the insert element; and
at least one row of balls arranged between the first and second rings
wherein the bearing race of the first ring has a concave inner profile in cross section and at least one thrust surface extending from a first axial end of the bearing race obliquely toward the outside in the direction of the second ring.

2. The bearing according to claim 1, wherein the at least one thrust surface of the first ring has a frustoconical shape.

3. The bearing according to claim 1, wherein the first ring has an annular surface, the bearing race being formed from the annular surface and the thrust surface being connected with the annular surface.

4. The bearing according to claim 1, wherein, in cross section, the thrust surface extends obliquely from the first axial end of the bearing race on the inside of the concave inner profile of the bearing race.

5. The bearing according to claim 1, wherein the at least one thrust surface is a first thrust surface and the first ring further includes a second thrust surface extending from a second axial end of the bearing race opposite to the first axial end and obliquely toward the outside in the direction of the second ring.

6. The bearing according to claim 5, wherein the second thrust surface of the first ring is symmetrical to the first thrust surface relative to a radial plane passing through the center of the balls.

7. The bearing according to claim 1, wherein the at least one insert of the second ring includes two insert elements arranged in the casing on either side of a radial plane passing through the center of the balls.

8. The bearing according to claim 1, wherein the first ring is the inner ring of the rolling bearing and the second ring is the outer ring of the rolling bearing.

9. A steering column comprising:
a housing;
a shaft coaxial to the housing; and
at least one rolling bearing according to claim 1 mounted radially between the housing and the shaft.
